(19) United States
(12) Patent Application Publication
(10) Pub. No.: US 2014/0075454 A1
(43) Pub. Date: Mar. 13, 2014

(54) EFFICIENT DYNAMIC SUBSCRIPTION UPDATES IN A CONTENT MANAGEMENT SYSTEM

(71) Applicants: Khanh M. Le, Round Rock, TX (US); Phong K. Truong, San Jose, CA (US); Alan T. Yaung, San Jose, CA (US)

(72) Inventors: Khanh M. Le, Round Rock, TX (US); Phong K. Truong, San Jose, CA (US); Alan T. Yaung, San Jose, CA (US)

(73) Assignee: INTERNATIONAL BUSINESS MACHINES CORPORATION, Armonk, NY (US)

(21) Appl. No.: 13/615,303

(22) Filed: Sep. 13, 2012

(51) Int. Cl. G06F 9/54

(52) U.S. Cl. CPC G06F 9/542
USPC 719/318

(57) ABSTRACT

Provided are a method, computer program product, and system for a dynamic subscription update for multiple queue event systems. A subscription request, including one or more conditions is received. A first subscription object, containing the one or more conditions in the subscription request, is selected from a first set of subscription objects. The first subscription object is moved to a second set of subscription objects. A second subscription object is generated based on the first subscription object. The second subscription object is updated with a generated subscription version and the subscription request. The second subscription object is added to the first set of subscription objects. In response to receiving the one or more conditions, a first event is generated using the second subscription object. The first event including the generated subscription version and the one of more conditions. The first event is added to a collection of first events.

### FIELD

Embodiments of the invention relate to event subscription mechanisms for content management systems.

### BACKGROUND

A content management system (CMS) (also known as an enterprise content management system (ECMS)) may be described as a software system used to store and organize unstructured content. This unstructured content includes (but is not limited to) documents, images, audio files, streaming videos, reports, business records, and Web content. Integrating a CMS with other business applications enables a business to link a business process to changes in content. For example, a business may desire business process management software to manage the approval process of all new insurance claims entered into the CMS. The integration is often accomplished by applications (such as business process applications) subscribing to CMS events that indicate a CMS command was applied to a type of content. Conventional CMS systems may provide a mechanism to enable all applications to receive all events, or to filter events so that specific applications will receive events that meet filter criteria. Applications receiving a filtered event would then make requests for attributes associated with the event from the CMS system. Such an approach does not provide an efficient mechanism for distributing events to applications with specific interests. Further, accessing the attributes after the event is provided may not be possible if the CMS deleted the attributes as part of the CMS command.

An improved approach enables applications to request the generation of custom events through a subscription mechanism. Subscription requests are made to provide custom events with specific attributes. However, providing such customized events increases the workload on the CMS and may reduce the overall performance. A conventional CMS may balance the need for customized events against performance by splitting the work with a dual event system. A first event captures the attributes, followed by the generation of one or more customized second events for applications. However, subscription updates are constrained in the dual event system due to the inherent time delay between the generation of the first event and the generation of the second events. Thus, there is a need for a CMS to use multiple events and dynamically respond to subscription changes.

### SUMMARY

Provided are a method, computer program product, and system for providing a dynamic subscription update for a multiple queue event systems. A subscription request, including one or more conditions is received. A first subscription object, containing the one or more conditions in the subscription request, is selected from a first set of subscription objects. The first subscription object is moved to a second set of subscription objects. A second subscription object is generated based on the first subscription object. The second subscription object is updated with a generated subscription version and the subscription request. The second subscription object is added to the first set of subscription objects. In response to receiving the one or more conditions, a first event is generated using the second subscription object. The first event including the generated subscription version and the one of more conditions. The first event is added to a collection of first events.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing architecture in accordance with certain embodiments.

FIG. 2 illustrates, in a flow diagram, the process of updating a subscription object in response to receiving a subscription request, in accordance with certain embodiments.

FIG. 3 illustrates, in a flow diagram, the generation of a first event in accordance with certain embodiments.

FIG. 4 illustrates, in a flow diagram, the generation of a second event in accordance with certain embodiments.

FIG. 5 illustrates, in a simplified block diagram an exemplary hardware implementation of a computing system, in accordance with an embodiment of the invention.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvements over technologies found in the marketplace, or to enable others of ordinary skill in the art to understand the embodiments disclosed herein.

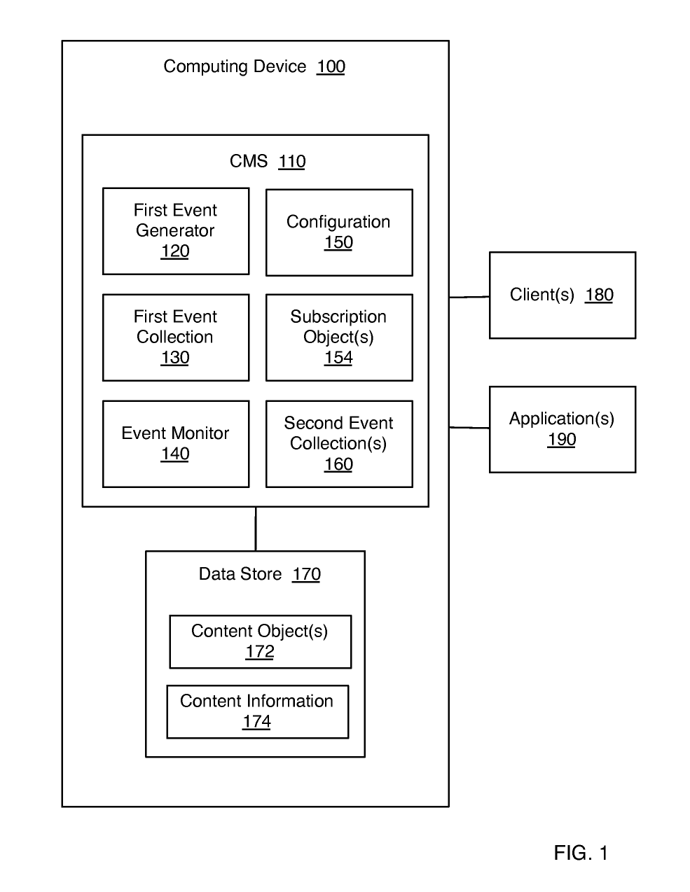

FIG. 1 illustrates, in a block diagram, a computing architecture in accordance with certain embodiments. A computing device 100 includes a content management system (CMS) 110, and a data store 170. The computing device 100 is coupled to one or more clients 180 and one or more applications 190. The CMS 110 includes a first event generator 120, a first event collection 130, an event monitor 140, a configuration 150, one or more subscription objects 154, and one or more second event collections 160. The data store 170 includes content objects 172, and content information 174. In certain embodiments, the computing device 100 contains more than one data store 170.

A content object 172 may comprise a document (e.g., a word processing document, Hypertext Markup Language (HTML) page, Extended Markup Language (XML) page, etc.), multimedia file (still images, motion picture), database table, or data spreadsheet, etc. The content information 174 provides information regarding the content objects 172. In certain embodiments, the content information 174 is stored in the CMS 110 in a database table. In certain other embodiments, the content objects 172 are stored in the CMS 110. Regardless of the location of the content objects 172, the CMS 110 controls access to the content objects. The CMS 110 allows users (e.g., humans and machines) to perform operations (e.g. create, read, update, delete, move, check-in, checkout) on content objects 172, and those operations generate conditions. In certain embodiments, the CMS 110 classifies each content object 172 with a content type; for example, an insurance claim form stored as a content object 172, may be classified as an “insurance claim” content type. In an embodiment, the object type information is stored in the content information 174. In certain embodiments, operations also generate an object type conditions; e.g. a “create” operation on an “insurance claim” content type would generate two conditions—“create” and “insurance claim.”

A subscription request provides the conditions to generate an event and the information to include in the event. In certain embodiments, the configuration 150 provides a user interface to a client 180 to facilitate the generation of a subscription request. A subscription object 154 is created or modified based on the subscription request, and is used to generate events. In certain embodiments, the subscription object 154 contains the conditions subscribed to, the subscription version, and information required for generating second events. In an embodiment, the information to generate second events includes the location of the second event collection 160 to receive each second event, and the attributes to include in each second event. In certain embodiments, the attributes may include attributes describing the content and attributes associated with the specified conditions. The configuration 150 manages the creation and maintenance of the subscription objects 154. The configuration 150 places each subscription object 154 in either a first set of subscription objects, or a second set of subscription objects; a particular subscription object 154 does not reside in both the first set of subscription objects and the second set of subscription objects. In one embodiment, the subscription objects 154 are stored in a database table and separated into a set of subscription objects with a column value indicating the set. In certain embodiments, the first set of subscription objects are known as the current set of subscription objects, and the second set of subscription objects are known as the prior set of subscription objects.

The first event generator 120 receives conditions, determines whether a subscription object matches the conditions, and if so, generates a first event according to the matching subscription object. The first event is placed in a first event collection 130 and then later removed by the event monitor 140. The event monitor 140 uses the information in the first event, and the subscription object 154 used to generate the first event 130, to generate one or more second events 160. In one embodiment, a selected subscription object is used to generate a second event for each application listed in the selected subscription object; each second event is placed in a second event collection 160, located according to information in the selected subscription object. In certain embodiments, the first subscription set contains the subscription objects to be used to generate the first events, and the second subscription set contains the subscription objects no longer used to generate first events, but may be used to interpret the information in existing first events.

In an embodiment, the subscription objects 154, content information 174, and one or more second events are stored in database tables. In certain embodiments, the first event collection is implemented as a queue, and/or at least one, second event collection 160 is implemented as a queue. In an embodiment, at least one, second event collection 160 may reside outside of the CMS 110 and be implemented with a message queue service.

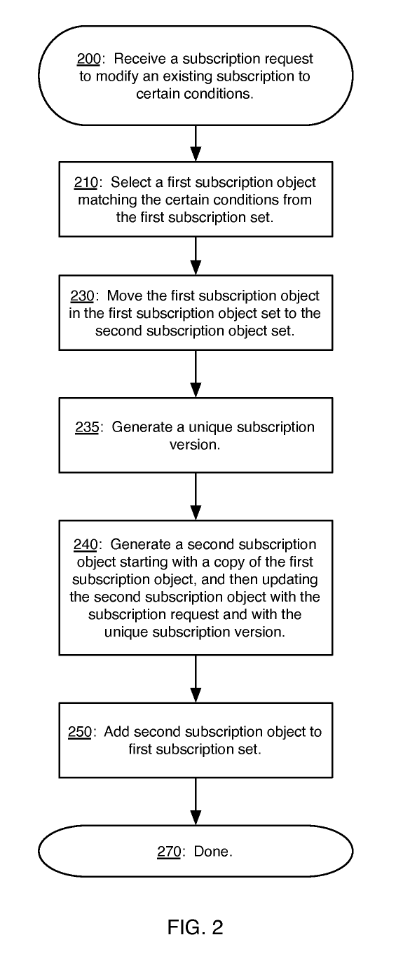

FIG. 2 illustrates, in a flow diagram, the process of updating a subscription object in response to receiving a subscription request, in accordance with certain embodiments. Control begins at block 200 with the receiving of a subscription request to modify an existing subscription to certain conditions, and processing continues to block 210. For example, an existing subscription matching conditions “create” and “insurance claim” generates an event comprising the attribute “author,” and request is received to add the attribute “timestamp” to the generated events. In block 210, a first subscription matching the certain conditions is selected from the first subscription set. Processing continues in block 220 where the first subscription object is moved to the second subscription set. Processing continues to block 235 where a unique subscription version is generated and processing continues to block 240. The subscription version must be unique across the subscription objects with the same conditions. For example, if a subscription version “1” exists for the subscription object matching the conditions “create” and “insurance claim” then another subscription object with the same conditions cannot have a generated subscription version equal to “1.” In block 240, a second subscription object is generated by starting with a copy of the first subscription object, updating the second subscription object with the subscription request and with the generated unique subscription version. Processing continues to block 250, where the second subscription object is added to the first subscription set, followed by block 270 where processing is complete. In an embodiment, the first subscription objects have a common subscription version; a change to the subscription version for one first subscription object will change the subscription version for all first subscription objects. In another embodiment, a change to one first subscription object will cause all first subscription objects to be moved to the second subscription object set, and cause new first subscription objects to be generated with unique subscription versions. In an embodiment, the processing from block 210 through 270 is performed synchronously. In certain embodiments the processing between blocks 240-250 is performed within an atomic database transaction, and may replace the move step with a copy step, however the changes are not performed until the transaction is committed.

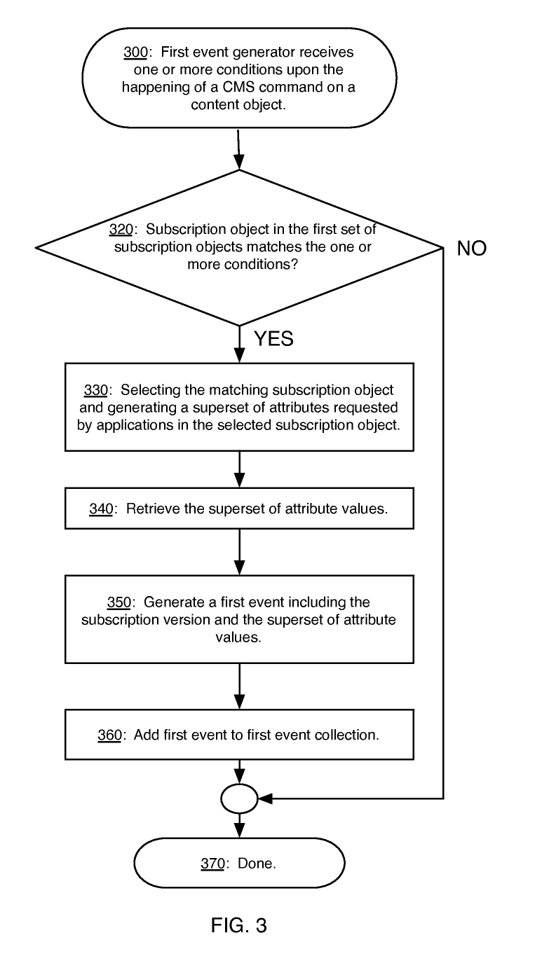

FIG. 3 illustrates, in a flow diagram, the generation of a first event with the first event generator 120, in accordance with certain embodiments. Control begins at block 300 where the first event generator 120 receives one or more conditions upon the happening of a CMS command on a content object 172, and processing continues to block 320. In certain embodiments, the CMS does not complete the command until the first event generator 120 generates the first event. Block 320 determines if a subscription object matching the conditions exists in the first set of subscription; if not processing ends at block 370; otherwise processing continues to block 330. Block 330 selects the matching subscription object and generates a superset of attributes requested by applications in the selected subscription object. Processing continues to block 340 where the values for the superset of attributes are retrieved and processing continues to block 350. In certain embodiments, the attributes include attributes associated with the CMS command (e.g. time stamp, user requesting) and attributes associated with the object entry 172 (e.g. author). In block 350, the first event is generated including the subscription version and the superset of attribute values. Processing continues to block 360 where the first event is placed in a first event collection 130, followed by block 370 where processing is complete. In certain embodiments, the first event collection 130 is a queue implemented with a database table and the first event is a row in that table.

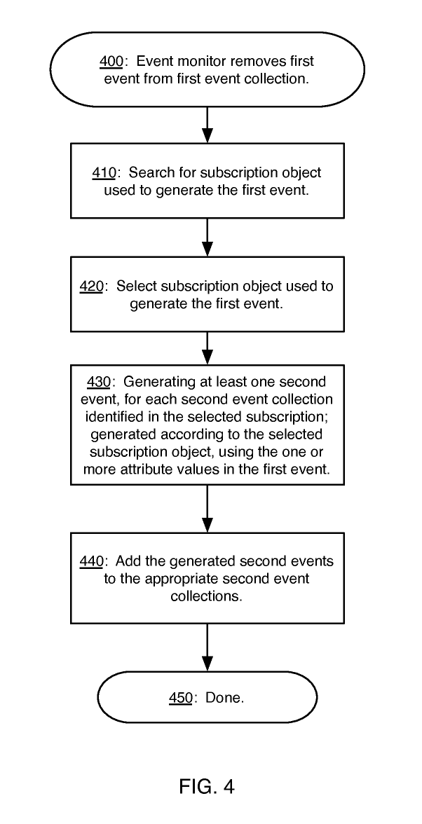

FIG. 4 illustrates, in a flow diagram, the generation of a second event in accordance with certain embodiments. Control begins at block 400 where the event monitor 140 removes the first event from the first event collection 130. Processing continues to block 410 where a search is performed to locate the subscription object used to generate the first event, and processing continues to block 420. In an embodiment, the conditions and subscription version stored in the first event are used to uniquely identify the subscription object used to generate the first event. In an embodiment the search begins in the second set of subscription objects, and if not found continues with a search through the first set of subscription objects. In block 420, the subscription object used to generate the first event (found in block 410) is selected. Processing continues in block 430 where a second event is generated for each second event collection identified in the selected subscription; generated according to the selected subscription object and attribute values in the first event, and processing continues to step 440. In an embodiment the selected subscription object contains the list of attributes to provide to each second event collection; the attribute values in the first event are used to generate the second events. In block 440, the one or more generated second events are added to the appropriate second event collections and processing ends at block 450. In an embodiment, the second event collections are queues described with a name, and the information required to connect to the queue is configured using configuration 150. In certain embodiments more than one second event may be generated for a second event collection with the user of application names; each application may have a separate second event and if two or more applications indicate the same second event collection more than one second event may be generated for the second event collection.

In certain embodiments, the first event generator 120 operates in a synchronous fashion and the event monitor 140 operates asynchronously. In certain embodiments the event monitor 140, monitors first events 130 and second events 160, and purges subscription objects 154 in the second set of subscription objects that are not referenced in existing first or second events.

A simple example is now presented to illustrate the a subscription change occurring after the internal event is generated but before the subscription event is processed, in accordance with certain embodiments:

In this example, a first subscription object exists with a version identifier of “1” and conditions “CREATE” and “INSURANCE CLAIM.” Additionally, in this example, the first and second subscription sets are implemented in a single database table; the subscription sets are identified by the value contained in the column “FIRST OR SECOND.” The subscription object specifies the generation of a second event including the attribute value of USERID, and enqueueing the second event on the APPLICATIONS queue. The existing subscription object 154 in table form may be represented as:

| | FIRST OR | | |
|---|---|---|---|
| CONDITIONS | SECOND | VERSION | QUEUE [ATTRIBUTES] |
| CREATE, | FIRST | 1 | APPLICATIONS[USERID] |
| INSURANCE | | | |
| CLAIM | | | |

The CMS receives a command to create a new content object 170 of the type “INSURANCE CLAIM” by a user with USERID=A. The first event generator 120 receives the conditions, and locates a subscription object in the first set of subscription objects matching the conditions. In this example, the matching subscription object has a version of “1,” indicates that second queue location as “APPLICATIONS” and the attribute to provide is “USERID.” Accordingly, the first event generator 120 generates a first event including the conditions (CREATE, INSURANCE CLAIM), superset of attributes (USERID=A) and the version identifier (1). The first event is enqueued on the first event queue 130.

Before the first event is removed and processed by the event monitor 140, a subscription request is made to generate a second event upon the happening of conditions “CREATE” and “INSURANCE CLAIM” and enqueueing the second event to second queue identified as “PROCESSING.” The attribute values requested are USERID, and CONTENT NAME. Upon receiving the request, the configuration 150 determines a subscription object 154 matching the conditions is in the first set of subscription objects. The subscription object is selected and moved to the second set of subscription objects, a new subscription object is generated based on a copy of the selected subscription object, a new version is generated to be “2” and information is updated to include the information is the subscription request. The new subscription object is added to the first subscription object set. The resulting subscription object table is shown below:

| | FIRST OR | | |
|---|---|---|---|
| CONDITIONS | SECOND | VERSION | QUEUE [ATTRIBUTES] |
| CREATE, | FIRST | 2 | APPLICATIONS[USERID], |
| INSURANCE | | | PROCESSING[USERID, |
| CLAIM | | | CONTENT NAME] |
| CREATE, | SECOND | 1 | APPLICATIONS[USERID] |
| INSURANCE | | | |
| CLAIM | | | |

A new insurance claim is created named “claim form B” by user id B. The first event generated includes the conditions (CREATE, INSURANCE CLAIM), the superset of attributes (USER ID=B, CONTENT NAME=claim form B), and version ID (2).

The event monitor dequeues the first event from the first event queue and uses the conditions and version information (CREATE, INSURANCE CLAIM and VERSION=1) in the first event to locate the subscription object used to create the event. The matching subscription object is in the second subscription set and requires the second event to be enqueued to the APPLICATIONS queue and the second event contains USERID=A. The event monitor dequeues the next first event from the first event queue and uses the conditions and version information the first event information (CREATE, INSURANCE CLAIM and VERSION=2) to locate the subscription object used to create the event. The matching subscription object is in the first set and requires two second events to be generated: one event for the APPLICATIONS queue with the event containing USERID=B, and one event for the PROCESSING queue with the event containing USER ID=B, CONTENT NAME=claim form B.

The dual queue subscription system enables efficient use of resources by dividing the work required to generate the events into two steps, however, there is a delay between the processing of the first event and the second event. Conventional two queue subscription systems had difficulty responding to subscription changes occurring while events are present in the first event queue. Conventional systems have restricted changes until the first queue is flushed. Another conventional system (self-describing) placed a greater load on the first event generator and larger payloads in the first event, thereby eliminating the need to use the subscription to create the second events. Such a system defeats the advantages provided by providing the least amount of information in the first event and the offloading of processing to the event monitor 140. Providing the superset of attribute values, the conditions, and the unique version ID of the subscription in the first event provides a minimal amount of information required to complete the generation of the second events.

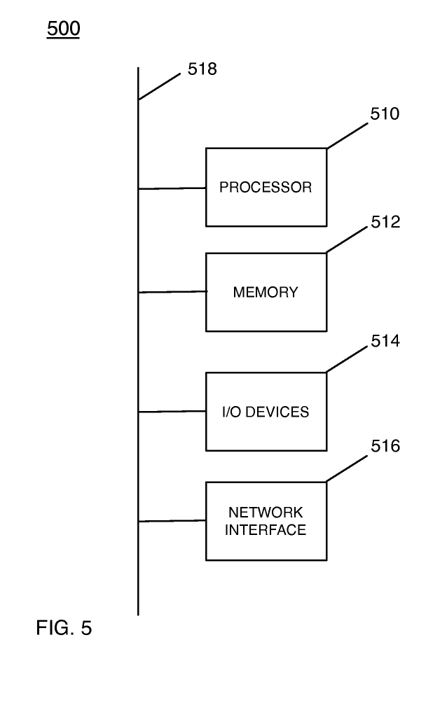

FIG. 5 illustrates, in a simplified block diagram an exemplary hardware implementation of a computing system, in accordance with an embodiment of the invention.

Referring now to FIG. 5 block diagram illustrates an exemplary hardware implementation of a computing system in accordance with which one or more components/methodologies of the invention may be implemented, according to an embodiment of the invention.

As shown, the techniques for controlling access to at least one resource may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g. keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A dynamic subscription update method comprising:
receiving a subscription request including, one or more conditions for generating a first event and information, wherein the information includes one or more attributes to include in a second event and a location for a second event queue, by at least one computing processor;
selecting from a first set of subscription objects, a first subscription object containing the one or more conditions, moving the first subscription object to a second set of subscription objects, generating a subscription version identifier, wherein the subscription version identifier is unique, generating a second subscription object based on the first subscription object, updating the second subscription object with the subscription version identifier and the subscription request, adding the second subscription object to the first set of subscription objects, by the at least one computing processor;
responsive to receiving the one or more conditions, selecting the second subscription object, and generating a first event including the subscription version identifier, the one or more conditions, and the information required for generating the second event, and adding the first event to a first event queue, by the at least one computing processor; and
upon removing the first event from the first event queue, selecting a subscription object with the subscription version identifier matching the subscription version identifier in the first event, and generating a second event from at least a portion of the first event, according to the information, by the at least one computing processor.

2. (canceled)

3. The method of claim 1, wherein the subscription objects are implemented as rows in a database table.

4. The method of claim 1, wherein the one or more conditions include a command affecting a content object and a content object type.

5. (canceled)

6. The method of claim 2, wherein the first set of subscription objects is implemented as a database table.

7. (canceled)

8. A dynamic subscription update system comprising:
a processor; and
a memory containing program code which when executed by the processor is configured to perform an operation, comprising:
receiving a subscription request including, one or more conditions for generating a first event and information, wherein the information includes one or more attributes to include in a second event and a location for a second event queue;
selecting from a first set of subscription objects, a first subscription object containing the one or more conditions, moving the first subscription object to a second set of subscription objects, generating a subscription version identifier, wherein the subscription version identifier is unique, generating a second subscription object based on the first subscription object, updating the second subscription object with the subscription version identifier and the subscription request, adding the second subscription object to the first set of subscription objects;
responsive to receiving the one or more conditions, selecting the second subscription object, and generating a first event including the subscription version identifier, the one or more conditions, and the information required for generating the second event, and adding the first event to a first event queue; and
upon removing the first event from the first event queue, selecting a subscription object with the subscription version identifier matching the subscription version identifier in the first event, and generating a second event from at least a portion of the first event, according to the information.

9. (canceled)

10. The system of claim 8, wherein the subscription objects are implemented as rows in a database table.

11. The system of claim 8, wherein the one or more conditions include a command affecting a content object and a content object type.

12. (canceled)

13. The system of claim 8, wherein the first set of subscription objects is implemented as a database table.

14. (canceled)

15. A computer program product for dynamic subscription update, the computer program product comprising a non-transitory computer readable storage medium having computer readable program code embodied therein capable of being executed to perform operations comprising:
receiving a subscription request including, one or more conditions for generating a first event and information, wherein the information includes one or more attributes to include in a second event and a location for a second event queue;
selecting from a first set of subscription objects, a first subscription object containing the one or more conditions, moving the first subscription object to a second set of subscription objects, generating a subscription version identifier, wherein the subscription version identifier is unique, generating a second subscription object based on the first subscription object, updating the second subscription object with the subscription version identifier and the subscription request, adding the second subscription object to the first set of subscription objects;
responsive to receiving the one or more conditions, selecting the second subscription object, and generating a first event including the subscription version identifier, the one or more conditions, and the information required for generating the second event, and adding the first event to a first event queue; and
upon removing the first event from the first event queue, selecting a subscription object with the subscription version identifier matching the subscription version identifier in the first event, and generating a second event from at least a portion of the first event, according to the information.

16. (canceled)

17. The computer program product of claim 15, wherein the subscription objects are implemented as rows in a database table.

18. The computer program product of claim 15, wherein the one or more conditions include a command affecting a content object and a content object type.

19. (canceled)

20. The computer program product of claim 15, wherein the first set of subscription objects is implemented as a database table.
